(19) United States
(12) Patent Application Publication
(10) Pub. No.: US 2005/0286262 A1
(43) Pub. Date: Dec. 29, 2005

(54) Lighting and/or signalling device with optical guide

(76) Inventors: Jean-Claude Gasquet, Bobigny Cedex (FR); Michel Andrieu, Bobigny Cedex (FR)

Correspondence Address: MORGAN & FINNEGAN, L.L.P., 3 WORLD FINANCIAL CENTER, NEW YORK, NY, 10281-2101, US

(21) Appl. No.: 11/158,768

(22) Filed: Jun. 21, 2005

(30) Foreign Application Priority Data
Jun. 24, 2004 (FR) 04 06 945
Sep. 7, 2004 (FR) 04 09 476

(51) Int. Cl. F21V 7/04

(52) U.S. Cl. 362/555

(57) ABSTRACT

The invention concerns a light and/or signalling device for a motor vehicle comprising
at least one light engine (2), comprising at least one light emitting diode (3) emitting a light beam in the direction of the engine, in particular along the axis (X) of the said engine, and
at least one optical guide (G), one end (e1) of which is illuminated by the or at least one of the light emitting diodes, this optical guide being able to emit light, in particular over all or part of its length,
the optical guide comprising at least one blind orifice (12, 13) produced in the thickness of the said optical guide and situated opposite the light engine (2), and diverting the light beam, in particular by a lateral reflection of the latter.

### FIELD OF THE INVENTION

The invention concerns a lighting and/or signalling device equipping a motor vehicle and comprising at least one light engine and an optical guide able to propagate the light axially and/or laterally. The invention also concerns a vehicle comprising such a lighting or signalling device.

The invention finds applications in the field of vehicles travelling on the road and in particular motor vehicles. In particular it finds applications in the field of lighting and signalling on these vehicles on the road. It also applies to the field of the internal lighting of vehicles.

### PRIOR ART

In the field of lighting and signalling on motor vehicles various types of device are known, amongst which there are essentially:
lighting devices situated at the front of the vehicle with, in particular, vehicle lights equipped with side lights having low light intensity and range, passing or dipped lights having a stronger light intensity and a range on the road of around 110 metres and main-beam lights having a long light range and producing a vision area on the road of around 200 metres,
lighting devices situated at the rear of the vehicle with, in particular, the reversing lights,
signalling devices situated at the front (or on the side) of the vehicle with in particular direction indicators, flashing repeaters, DRL (daytime running lights in English terms) or daytime lights, and
signalling devices situated at the rear of the vehicle with in particular fog lights, rear lights, direction indicators and stop lights,
the internal lighting devices with in particular the main (front, central or rear) courtesy lights,
lighting participating in the style (illuminated style lines on the dashboard, door trim or roof lighting).

At the present time it is known how to use, in lighting devices and/or signalling devices, one or more optical guides for propagating a light beam.

For example, from the document DE-A-101 53 543, a lighting device for a motor vehicle is known, comprising a light guide provided with optical deflection elements on one of its sides, in order to direct the light propagated in the guide to the other one of its sides, at least one entry point for the light on the side provided with deflection elements, and at least one reflective wall for reflecting the incident light on the deflection elements. The light guide comprises an orifice with an axis transverse to the axis of the guide and transverse to the direction of the incident light. A reflective wall is formed by a wall of this orifice.

Another example of such a lighting device is described in the document EP-A-0 515 921. This device is designed to provide lighting inside a vehicle whilst being incorporated in a door handle. The light intensity in a direction orthogonal to the length of the optical guide does not have any favoured zone and remains relatively low.

However, it is desirable for a signalling or lighting device, generally oriented towards the outside of the vehicle, to make it possible to clearly attract the attention of other drivers and pedestrians.

In addition, it is advantageous, for a motor manufacturer, to use special signalling or lighting in order to give, through its visual appearance, a particular style to his vehicles. It is for example advantageous to provide ambient lighting for emphasising the style lines and (or) to position oneself inside the vehicle.

### DISCLOSURE OF THE INVENTION

The aim of the invention is precisely to remedy the drawbacks of the techniques mentioned above. To this end, the invention proposes a lighting or signalling device in which the light emitted by the light source can be propagated by the optical guide on the one hand axially in order to create a zone with high light intensity and on the other hand laterally in order to create a zone of lesser light intensity over a greater length. The light can also be propagated only laterally, in particular in order to create illumination of great length. For this, the device of the invention comprises at least one optical guide and at least one light source placed close to the optical guide. The optical guide comprises, in its thickness, at least one blind orifice situated opposite the light source and providing distribution of the light rays axially and/or laterally.

More precisely, the invention concerns a lighting and/or signalling device for a motor vehicle, comprising
at least one light engine, comprising at least one light emitting diode emitting a light beam in the direction of the engine, in particular along the axis of the said engine, and
at least one optical guide, one end of which is illuminated by the or at least one of the light emitting diodes, this optical guide being able to emit light, in particular over all or part of its length,
the optical guide comprising at least one blind orifice produced in the thickness of the said optical guide and situated opposite the light engine and diverting the light beam, in particular by a lateral reflection thereof.

The optical guide therefore has an end which receives the light beam emitted by the or at least one of the light emitted diodes.

Such an optical guide provides a distribution of the light rays axially or laterally, or only laterally, particularly in the case where even lighting is sought over a great length (for example dashboard, roof or door trim lighting).

Invention may comprise one or more of the following characteristics:
the optical guide comprises two blind orifices,
the optical guide comprises a groove produced in the thickness of the said guide, along the length of the optical guide. Such a groove provides diffusion of the light rays towards the exit face of the guide,
the groove comprises a diffusing zone situated at the bottom groove of the optical guide. This diffusing zone accentuates the diffusion effect of the groove,
the diffusion zone is close to the centre of the cross section of the optical guide,
the diffusion zone is provided with micro-diffusions, the size of which is around one tenth of a millimetre,
the micro-diffusions can be micro-prisms, roughnesses, microfresnels or frosting, etc,
the groove of the optical guide has a changing shape,
the light engine is placed in a central position, between at least two parts of the optical guide. In this way, the light rays can be emitted in the two parts of the optical guide.

The invention also concerns a motor vehicle equipped with at least one such lighting and/or signalling device.

### BRIEF DESCRIPTION OF THE DRAWINGS

FIG. 1 depicts a view partially in cross section of a first embodiment of the device according to the invention.

FIG. 2 depicts a view partially in cross section of a second embodiment of the device according to the invention.

FIG. 3 depicts a view of a section of the optical guide according to the invention.

FIG. 4 depicts a view in perspective of an example of a changing groove.

FIG. 5 depicts an example of change in the light in the optical guide in FIGS. 1 and 2.

FIG. 6 depicts an example of a signalling device with hot spots and linear zones.

### DETAILED DESCRIPTION OF EMBODIMENTS OF THE INVENTION

The invention concerns a lighting or signalling device of the light type for a motor vehicle allowing axial and/or lateral diffusion of the light. This device comprises at least one light engine emitting a light beam and at least one optical guide intended to propagate this light beam and emitted over its length.

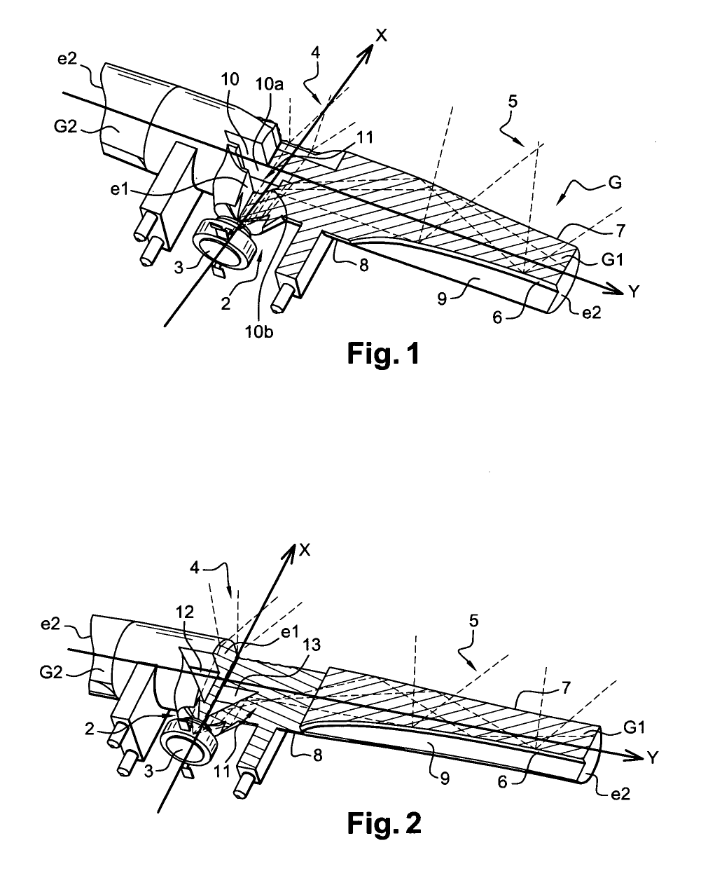

The first embodiment of the lighting or signalling device of the invention is depicted in FIG. 1. This FIG. 1 shows a view partially in section of an optical guide and light engine according to the invention.

The optical guide is an elongate solid element, for example having a cylindrical cross section, made from transparent material which ensures the propagation of the light beam emitted by the light source from an end close to the light source as far as an opposite end. The cross section of the guide may be different, for example oval or even polygonal of the square type, or with a base with prisms or local reliefs. This optical guide can have various geometric shapes. It may for example have the shape of a circle or an arc of a circle, or be rectilinear or comprise curved zones and rectilinear zones. In the embodiment depicted in FIG. 1, the optical guide is of the rectilinear type with a cylindrical cross section. Such a rectilinear optical guide can be used for example in the production of a raised stop light, that is to say the third stop light situated opposite the rear window of a vehicle and referred to as CHMLS (Central High Mounted Lamp Stop, in English terms).

In the embodiment in FIG. 1, the optical guide G comprises a first guide part G1 and a second guide part G2. Each guide part G1 and G2 has a first end e1, common to the two parts, and a second end e2, opposite to the end e1. The optical guide G receives the light beam emitted by the light engine 2 close to the end e1. In other words, the light engine 2 that emits the light beam is placed close to the central zone of the optical guide G, that is to say close to the end e1.

The light engine 2 emits a processed light beam. For this purpose, the light engine 2 comprises a high-power light emitting diode, or LED, and an optical system for processing the light. The light emitting diode 3 is preferably a hemispherical diode, of the Lambertian type, that is to say it comprises an emitting zone in the form of a cone, for example of 120°. Such a diode has the advantage of emitting a light beam in several directions. This light beam is then converted by the optical system into parallel sessions.

The optical system can comprise a reflector whose role is to modify the distribution of the light flux of the light emitting diode. It can comprise a Fresnel lens diverting the light surface to produce a uniform distribution of the light. The light engine 2 therefore ensures the emission of the light and its conversion into parallel beams, ready to be redistributed in the optical guide G. The light beam is thus emitted by the light engine 2, in the optical guide 3, in a main emission direction, or axial direction, that is to say along the axis X of the light engine 2. In other words, the rays emitted by the LED 3 are transformed by the optical system into parallel light rays. The light rays therefore enter, through the end e1, the optical guide G, parallel or substantially parallel to the axis X.

Some of the rays of this light beam pass through the guide axially: these are the axial light rays 4. These axial light rays 4 provide a first signalling function, that is to say they form, on the exit face 7 of the optical guide G, a high-intensity light spot, referred to as the hot spot.

Other rays of the light beam are totally reflected towards the end e2 of the guide G: these are the lateral rays 5. The principle of total reflection is an optical phenomenon which allows the transmission of light in an optical guide. When a light ray passes from one medium to another medium having a different refractive index, its direction is changed. This is the refraction effect. For a certain angle of incidence, and if the index of the initial medium is higher than that of the final medium, the light ray is no longer refracted, it is totally reflected: total reflection is spoken of.

More precisely, some rays are reflected in the part G1 of the optical guide, other rays are reflected in the part G2 of the said guide. Naturally the light engine 2 can also be placed at the end of a single part of the optical guide. In this case, the light beam comprises rays propagated axially and rays reflected towards a single side of the optical guide.

FIG. 1 depicts in detail, in a view in section, the light rays in the part GI of the guide. The part G2 of the optical guide is shown in a perspective view.

The optical guide G comprises two faces:
a first smooth face 7 forming the exit face of the optical guide,
a second face 8 opposite to the exit face 7 forming the diffusion face of the optical guide. This face 8 provides the diffusion of the light rays towards the exit face 7.

This diffusion face 8 comprises a groove 9. This groove 9 is a transverse recess, or a groove, forming a channel in the thickness of the optical guide G. The role of this groove 9 is to return the light towards the exit face 7, in particular in a diffuse manner, that is to say in the form of a light cone. This is because the light rays coming into contact with the bottom of the groove 9 are reflected in a diffuse manner according to their angle of incidence towards the exit face 7.

In order to improve the refraction by the groove 9, the latter comprises, in a preferred embodiment of the invention, a diffusing zone situated on the bottom 6 of the groove 9. As explained in more detail below, this diffusing zone comprises micro-diffusions which, according to the shape, diffuse the light beam with different patterns at the exit from the optical guide G.

As explained previously, the light rays emitted by the light engine 2 can pass through the optical guide axially in order to form a hot spot on the exit face 7 or be reflected laterally in the optical guide G. This lateral reflection is obtained, according to the invention, by means of at least one orifice.

In the embodiment in FIG. 1, the axial and/or lateral distribution is obtained by means of a single orifice 10. This orifice 10 is produced in the central zone of the guide G, that is to say at the junction of the parts G1 and G2 of the optical guide G. This orifice 10 is described only for the part G1 of the guide, it being understood that it is symmetrical, with respect to the axis X, in the part G2.

This orifice 10 is a through opening produced in the width of the optical guide. It is preferably produced in the central zone 11 of the guide, opposite the light engine 2. This orifice, asymmetric in shape, creates planar zones and inclined zones, in the central zone 11. This difference in level in the central zone 10 distributes the light beam in the main emission direction X and in lateral directions. The so called lateral directions are non-axial directions, that is to say directions forming a non-zero angle with the axis X. A lateral direction may for example be the direction along the axis Y of the guide G perpendicular to the axis X. It should be noted that the fact that the axes X and Y are in this example perpendicular is not a necessity of the invention: the light engine can also be associated with the light guide so that their respective axes are not exactly perpendicular. Axes means (in particular with regards to the light guide, which may be curved along its length) possibly the longitudinal axis passing through the tangent to the element when the latter is not substantially rectilinear.

Thus, when the light engine 2 emits a light beam, the latter propagates in the optical guide G. Some of the rays of this light beam (the rays referenced 4) are propagated in an axial direction X by the optical guide G. These axial rays 4 are propagated directly by the planar zones 10a of the orifice 10, towards the exit face 7, without undergoing any diversion and/or reflection. In other words, some of the light rays 4 are directly distributed towards the exit face 7 of the optical guide.

Another part of the light rays 5 are directed by the inclined zones 10b of the orifice 10. According to the angle of incidence of the light rays with the inclined zones 10b, the lateral rays 5, reflected by the inclined zones, may have different paths in the optical guide:
these rays 5 can be sent, by total deflection, towards the diffusion face 8 and then diffused by this face 8 to the exit face 7 of the optical guide. This diffusion is provided by the groove 9 itself and the diffusion zone of the said groove;
these light rays 5 can undergo one or more internal reflections (refractions by the exit face 7 and by the groove 9) before being returned, towards the exit face 7, by diffusion by the groove bottom.

The path of these lateral rays 5 depends in particular on the shape and dimensions of the orifice 10. By modifying this shape and/or these dimensions, it is possible to modify the distribution of the light towards the principle emission direction X and towards the lateral directions.

The lateral light rays 5 provide, in the device of the invention, a second signalling function, that is to say a linear signalling function. This second function consists of an illumination of lesser intensity than the first function but over a greater length. This signalling function of great length allows an effect of highlighting or luminous junction of two hot spots. The illumination of great length can also be achieved using 100% of the flux laterally.

FIG. 2 depicts a second embodiment of the device of the invention. As with FIG. 1, this FIG. 2 depicts the first part G1 of the optical guide G in a view in section and a second part G2 of the guide in a perspective view.

In this embodiment, the axial and/or lateral distribution of the light rays 4 and 5 are obtained by two orifices 12 and 13 produced in the width of the optical guide. These two orifices 12 and 13 are blind, that is to say they each form a cavity or hollow that does not go right through. They are preferably produced in the central zone 11 of the optical guide G, that is to say at the junction of the parts G1 and G2 of the said guide. These orifices 12 and 13 are situated opposite the light engine 2. They create in the guides G1 and G2 various cavity levels with planar zones and inclined zones, which distributes the light beam in the principal direction X and in lateral directions.

As in the embodiment in FIG. 1, when the light engine 2 emits a light beam, the latter propagates in the optical guide G. Some of the rays of this light beam (the rays referenced 4) are propagated in an axial direction X by the optical guide G. These axial rays 4 are propagated directly by the non hollow zones, towards the exit face 7, without undergoing any diversion and/or reflection. In other words, some of the light rays 4 are directly distributed towards the exit face 7 of the optical guide, thus providing an illumination of high intensity forming a hot spot.

Another part of the lateral light rays 5 is diverted through orifices 12 and 13. This is because the orifices 12 and 13 make it possible to retain the light rays emitted by the light engine 2. These rays thus retained are sent by refraction into the optical guide G. According to the depth of the orifices 12 and 13, the lateral rays 5 can have different paths in the optical guide:
some of these lateral rays 5 are sent by reflection to the diffusion face 8 and, more precisely, by the groove 9 in the face 8 which then provides the diffusion of these rays towards the exit face 7. This diffusion can further be improved by the presence of a diffusing zone situated on the bottom 6 of the groove 9;
another part of the lateral rays 5 undergoes internal multi-reflections in the guide, thus it is to say these rays 5 are reflected at least once towards the exit face 7 and then towards to diffusion face 8 before finally being diffused towards the exit face 7 of the optical guide. In this embodiment, the coefficient of reflection is close to 1, which has the effect that there is no, or almost no, loss of light energy during these multi-reflections.

The path of these light rays 5 depends in particular on the shape and depth of the orifices 12 and 13. By modifying this shape and/or these depths it is possible to modify the distribution of the light towards the main emission direction X and towards the lateral directions.

Thus, whatever the embodiment (the one in FIG. 1 or the one in FIG. 2), the light is distributed in the optical guide axially and laterally. It is distributed laterally in the part G1 of the optical guide and in the part G2 of the said optical guide. In addition, the multiple internal reflections make it possible to propagate the light as far as the ends e2 of the optical guide G. The optical guide can thus be relatively long, for example around 1300 mm.

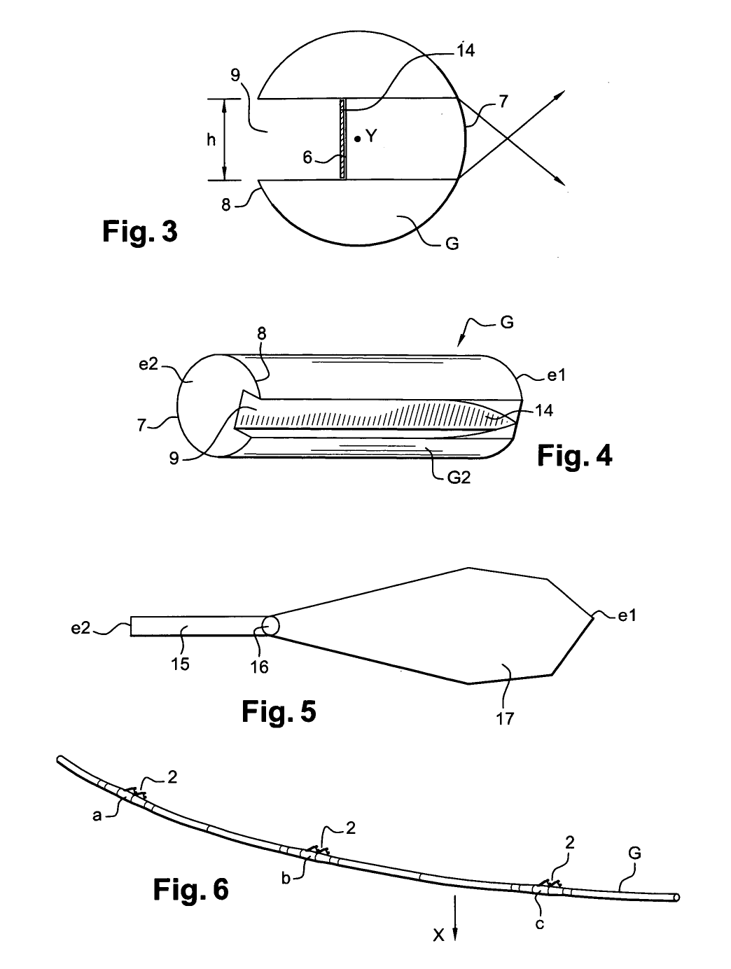

FIG. 3 depicts a cross section of the optical guide G of FIGS. 1 and 2. This is because, whatever the embodiment chosen (an opening-out orifice or two non-opening-out orifices) the cross section of the optical guide is the same. It can therefore be seen, in FIG. 3, that the optical guide G has a roughly circular cross section. It should be noted however that this cross section may have a shape different from circular, for example rectangular. In the embodiments described, the cross section is roughly circular with a diameter of around 8-12 mm.

This FIG. 3 shows the exit face 7 of the optical guide G as well as the diffusion face 8 with its groove 9. This groove 9 has a hollow shape, for example in the shape of a U, the base of the U being the bottom 6 of the groove 9. The bottom 6 of the groove is preferably close to the centre to the optical guide, that is to say situated close to the axis of symmetry of the optical guide.

The main effect of this groove 9 is to diffuse the light towards the opposite face, that is to say the exit face 7 of the optical guide. In order to improve the diffusion effect of the groove, the latter can comprise a diffusing zone 14. This diffusing zone 14 comprises diffusion means which effectively diffuse the light towards the exit face 7 of the optical guide G. These diffusion means can be micro-diffusions whose diameter is around one tenth of a millimetre.

These micro-diffusions can have different patterns, for example:
straight or curved serrations
micro-prisms with a triangular cross section
microfresnels
optical micro patterns, that is to say holes with a specific shape, produced in the material in order to improve the homogeneous aspect of the optical guide
roughnesses or frosting.

These various diffusion patterns give the optical guide a different visual appearance.

The diffusing zone 14 forms a diffusing band on the bottom 6 of the groove 9. This diffusing band 14 has a width h which is perfectly identical to the width of the bottom of the groove 9. The width h of the diffusing band 14 can be constant. It can also change so as to broaden the apparent luminance field for an observer.

FIG. 4 depicts, in a perspective view, an example of a groove with a changing shape. In this example, the shape of the groove 9 changes between an end e1 and an end e2 of the part G2 of the optical guide G. It is said that the groove undergoes a “morphing”, that is to say a progressive deformation of its shape. In this example the end e1, close to the light engine, has a groove shape 9 different from that of the end e2. The changing shape of the groove is a slow transformation from a groove with a small cylindrical cross section into a U-shaped groove. This is of course only one example. All kinds of changes can be envisaged, with enlargement of the cross section of the groove or reduction of this cross section or again an alternation between enlargement and reduction, the whole with change in shape of the cross section.

Choosing a cylindrical optical guide with a circular transverse section makes it possible to obtain, visually, an enlargement of the diffusing zone 14 by a conventional magnifying-glass effect. Thus the external visual appearance of the diffusion part is amplified by this magnifying-glass effect.

FIG. 5 shows an example of a light change in an optical guide. This FIG. 5 shows an example of the visual appearance of an optical guide when the groove has a changing shape. In this example, the change corresponds to an enlargement from a pseudo-circular cross section 15, from the end e2 to a central zone 16, as far as a totally flat zone 17. In other words, by means of a gentle change, the pseudo-circular cross section 15 is converted into a surface section 17. For this, the U shape of the groove 9 has been stretched in order to form a wide diffusing surface. This surface section 17 comprises a diffusing zone 19 of the groove 9. The diffusing zone 14 being relatively narrow, it spreads out over the whole of the rear of the surface section 17. Thus the diffusing surface appears much greater for an external observer, by a trompe l'oeil effect. This trompe l'oeil effect is obtained when the diffusing zone 14 is close to the centre of the groove 9.

An example of a signalling device according to the invention is illustrated in FIG. 6. In this example, several light engines 12 are placed along one and the same optical guide G in order to form a light line. By thus joining several light engines along the same optical guide or several joined optical guides, it is possible to produce optical zones of high light intensity alternating with less luminous zones of greater length.

It will be understood from the above description that the device of FIG. 6 comprises several hot spots, or more precisely as many hot spots as there are light engines. FIG. 6 shows three light engines 2 corresponding to three hot spots a, b, c. These hot spots a, b, c fulfil the first signalling function. The hot spots are connected together by one or more optical guides providing the very long signalling function.

This very long signalling function makes it possible to generate style effects, for example by emphasising the shapes of a vehicle. The device of the invention makes it possible for example to follow the periphery of the rear window or part of the body work. It can also be used to make internal door edge illuminations or raised stop lights.

In addition to the advantages given previously (in particular axial and lateral diffusion), the device of the invention has advantages from the point of view of manufacture. The manufacture of this device, and in particular of the optical guide used in this device, can be carried out by injection of a transparent material in a mould. It can be in a single piece, that is to say the optical guide is produced in one and the same piece, the housing being provided at the centre of the said guide for the light engine. The optical guide can also be produced in several pieces joined by connecting areas containing the housing for the light engine. These connecting areas are polished in order to minimise light flux losses.

Whatever the method of manufacturing the optical guide, the groove is produced, in the thickness of the said guide, when the material is injected into the mould. The presence of this groove considerably reduces the quantity of material and therefore the cooling time needed. The groove, just like the orifices, behaves as a cooling source in the mould, thus discharging the heat. The orifices can also be produced during the injection of the material into the mould by virtue of the presence of pieces whose shape corresponds to the required shape of the orifices. These pieces can be adjustable, which makes it possible to modify the depth of the orifices (in the second embodiment), which may thus be asymmetric.

The groove is produced by means of a blade mounted in the mould. This blade is polished on each side, thus making it possible to remove the guide easily from the mould, after cooling. This blade also can comprise, on its inside edge, roughnesses which will form on the bottom of the groove the patterns of the micro-diffusions. These roughnesses can have around 2-3 tenths of a millimetre. These roughnesses have shapes complementary to the required micro-diffusion patterns.

Where the micro-diffusions are optical micro-patterns, these may also be obtained, after cooling of the optical guide, by laser etching of the bottom of the groove.

In addition to the application to signalling lights, the applications in the field of internal lighting are also very varied. The purpose may be to create ambiance lighting, an effect of the function emphasising type, by illuminating a conduit over a great length. It is also possible to produce optical guides according to the invention where the middle part of the guide offers illumination of the reading light type, and where the lateral parts are for illumination of the ambiance lighting type.

1. A lighting and/or signalling device for a motor vehicle comprising:
a least one light engine, comprising at least one light emitting diode emitting a light beam in the direction of the engine, in particular along the axis of the said engine, and
at least one optical guide, one and of which is illuminated by the at least one of the light emitting diodes, this optical guide being able to emit light, in particular over all or part of its length,
wherein the optical guide comprises at least one blind orifice produced in the thickness of the said optical guide and situated opposite the light engine, and diverting the light beam, in particular by a lateral reflection of the latter.

2. A device according to claim 1, wherein the optical guide provides a distribution of the light rays axially and laterally or only laterally.

3. A device according to claim 1, wherein the optical guide comprises two blind orifices.

4. A device according to claim 1, wherein the optical guide comprises a groove produced in the thickness of the said optical guide, along the length of the guide.

5. A device according to claim 4, wherein the groove comprises a diffusing zone situated on a bottom of the groove.

6. A device according to claim 5, wherein the diffusing zone is close to the centre of the cross section of the optical guide.

7. A device according to claim 5, wherein the diffusing zone is provided with micro-diffusions, the dimensions of which are preferably around one tenth of a millimetre.

8. A device according to claim 7, wherein the microdiffusion comprise micro-prisms, roughnesses, microfresnels, frosting etc.

9. A device according to claim 4, wherein the groove has a changing shape.

10. A device according to claim 1, wherein the light engine is placed in a central position between at least two parts of the optical guide.

11. A device according to claim 1, being a vehicle signalling light or an internal vehicle lighting device.

12. A motor vehicle, wherein it is equipped with at least one lighting and/or signalling device according to claim 1.
